(19) United States
(12) Patent Application Publication
(10) Pub. No.: US 2008/0256476 A1
(43) Pub. Date: Oct. 16, 2008

(54) COPYING APPARATUS AND USER INTERFACE METHOD FOR THE SAME

(75) Inventors: Joon-kyu SEO, Seoul (KR); Hyun-ki KIM, Seoul (KR); Jung-won LEE, Seongnam-si (KR); Young-eun LEE, Seoul (KR); Hee-jeong BAE, Osan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/934,835

(22) Filed: Nov. 5, 2007

(30) Foreign Application Priority Data
Apr. 10, 2007 (KR) 10-2007-0035175

(51) Int. Cl. G06F 3/048

(52) U.S. Cl. 715/772

(57) ABSTRACT

Provided are a copying apparatus and a user interface method for the same. The user interface method includes displaying a first region which includes information on an original document, and displaying a second region which includes information on virtual copy paper; changing the display of the second region in accordance with an input setting instruction; and when a copy instruction is input, copying the original document in accordance with the display of the second region. According to the present invention, an intuitive interface which even inexperienced users can easily use may be implemented.

### CROSS-REFERENCE TO RELATED PATENT APPLICATION

This application claims the benefit of Korean Patent Application No. 10-2007-0035175, filed on Apr. 10, 2007, in the Korean Intellectual Property Office, the disclosure of which is incorporated herein in its entirety by reference.

### BACKGROUND OF THE INVENTION

1. Field of the Invention

The present invention relates to a copying apparatus and a user interface method for the same.

2. Description of the Related Art

The functions of apparatuses having a function of copying, such as copiers and multi-copiers, (hereinafter the apparatuses are referred to as copying apparatuses) have increased over time and have become more complicated. However, most users are not proficient at manipulating the copying apparatuses. Furthermore, although liquid crystal display (LCD) panels of the copying apparatuses are large-scaled and colorized, a copying apparatus merely includes touch screen buttons for setting options and manipulating functions on a screen. That is, a conventional button type interface is just implemented on an LCD panel and the copying apparatus does not provide an appropriate input method in consideration of convenience of the users. Accordingly, an interface which allows the users to copy documents easily and intuitively to desired forms is demanded.

### SUMMARY OF THE INVENTION

The present invention provides a copying apparatus having a user interface which allows users to copy documents easily and intuitively to desired forms and a user interface method for the same.

According to an aspect of the present invention, there is provided a user interface method for a copying apparatus, the method including displaying a first region which includes information on an original document, and displaying a second region which includes information on virtual copy paper which shows the expected result of copying; changing the display of the second region in accordance with an input setting instruction; and when a copy instruction is input, copying the original document in accordance with the display of the second region.

The displaying of the second region may include displaying preview information of the result of copying of the original document on the virtual copy paper.

The displaying of the first region may include scanning each page of the original document; and displaying the result of the scanning on the first region.

The displaying of the first region may include displaying a default page image which corresponds to each page of the original document on the first region.

If the setting instruction is to select and move a page of the original document shown on the first region onto the virtual copy paper, the changing of the display of the second region may include displaying the selected page on the virtual copy paper.

The setting instruction may be input when a user drag-and-drops the selected page to the virtual copy paper.

The displaying of the selected page may further include displaying remaining pages of the original document, except the selected page, to be mapped to other corresponding sheets of the virtual copy paper.

If the setting instruction is to select a first page of the original document shown on the first region and move the first page to a front page of the virtual copy paper and to select a second page of the original document and move the second page to a rear page of the virtual copy paper, the changing of the display of the second region may include displaying the first and second pages to be mapped to the front and rear pages of the virtual copy paper, respectively.

If the setting instruction is to select and move a plurality of pages of the original document shown on the first region, the changing of the display of the second region may include displaying the selected pages on a sheet of the virtual copy paper.

The displaying of the selected pages may further include displaying remaining pages of the original document in groups of a selected number, except the selected pages, to be mapped to other corresponding sheets of the virtual copy paper.

If the setting instruction is to adjust the size of the original page mapped to the virtual copy paper, the changing of the display of the second region may include displaying the original page by changing the size of the original page in accordance with the setting instruction.

If the setting instruction is to select a portion of the original page mapped to the virtual copy paper, the changing of the display of the second region may include displaying the original page by removing the unselected portion of the original page.

If the setting instruction is to change a position of the original page mapped to the virtual copy paper, the changing of the display of the second region may include displaying the original page by changing the position of the original page.

If the setting instruction is to set the position of stapling, the changing of the display of the second region may include displaying the original page mapped to the virtual copy paper by changing the position of the original page and displaying the stapled region on the virtual copy paper according to the set position of stapling.

The method may further include displaying one or more functional icons which correspond to types of inputtable setting instructions, wherein any of the functional icons can be added or removed by an input setting instruction.

According to another aspect of the present invention, there is provided a copying apparatus including a user interface unit; an output engine which copies an original document; a control unit which controls the user interface unit to display a first region which includes information on the original document, and to display a second region which includes information on virtual copy paper which is an expected result of copying, and when a setting instruction is input, controls the user interface unit to change the display of the second region in accordance with the setting instruction, and, when a copy instruction is input, controls the output engine to copy the original document in accordance with the display of the second region.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a copying apparatus according to an embodiment of the present invention;

FIG. 2 is a flowchart of a user interface method in order to manipulate a copying apparatus, according to an embodiment of the present invention;

FIG. 3 is a diagram of a user interface screen according to an embodiment of the present invention;

FIG. 4 is a diagram for showing an example of manipulating the user interface screen illustrated in FIG. 3 to copy a document in original scale, according to an embodiment of the present invention;

FIG. 5 is a diagram for showing an example of manipulating the user interface screen illustrated in FIG. 4 to copy a document in reduced or enlarged scale, according to an embodiment of the present invention;

FIG. 6 is a diagram for showing an example of manipulating the user interface screen illustrated in FIG. 3 to copy several pages of a document into one page, according to an embodiment of the present invention; and

FIG. 7 is a diagram for showing an example of manipulating the user interface screen illustrated in FIG. 4 to copy a portion of a page, according to an embodiment of the present invention.

### DETAILED DESCRIPTION OF THE INVENTION

Hereinafter, the present invention will be described in detail by explaining embodiments of the invention with reference to the attached drawings.

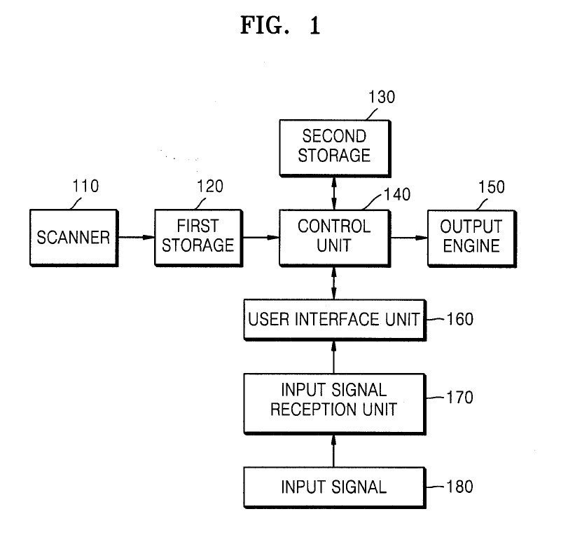

FIG. 1 is a block diagram of a copying apparatus according to an embodiment of the present invention.

Referring to FIG. 1, the copying apparatus includes a user interface unit 160 which provides an interface screen to which a user inputs instructions, an output engine 150 which copies an original document and outputs the result, an input signal reception unit 170 which receives an input signal 180, and a control unit 140 which interprets the input signal input through the input signal reception unit 170 and determines an instruction that the user wants, controls the change in the display of the user interface unit 160 in accordance with the input instruction, and controls the output engine 150 to copy the original document as the user wants. According to the present invention, the user interface screen is divided into a first region which includes information on the original document and a second region which displays virtual copy paper to show the result of copying in advance. The user may directly see how original pages of the document on the first region are to be copied on the second region and may determine the setting of the copier while seeing the result of copying in advance. The control unit 140 controls the user interface unit 160 to display the first and second regions and, when a setting instruction is input, to change the display of the second region in accordance with the setting instruction. Also, when a copy instruction is input by the user, the control unit 140 controls the output engine 150 to copy the original document in accordance with information included in the virtual copy paper of the second region.

The copying apparatus may further include a scanner 110 which scans the original document to be copied, a first storage 120 which stores the scanned document, and a second storage 130 which stores information on the setting instruction input by the user. The scanner 110 scans each page of the original document and stores the scanned page images into the first storage 120 and the control unit 140 reads the scanned page images from the first storage 120 and controls the user interface unit 160 to display the scanned page images on the first region of the interface screen. Also, if the user inputs the setting instruction by using the display of the first and second regions, the control unit 140 modifies the information on the setting instruction stored in the second storage 130 and controls the user interface unit 160 to change the display of the second region. The control unit 140 determines how to copy the original document with reference to the information of the second storage 130.

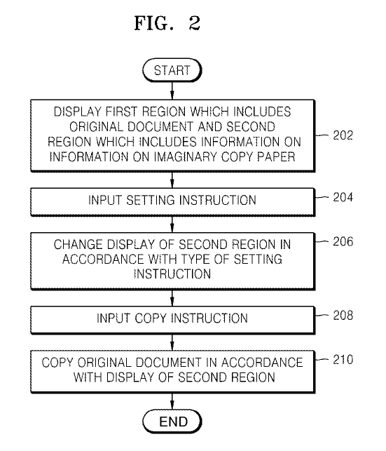

FIG. 2 is a flowchart of a user interface method for manipulating a copying apparatus, according to an embodiment of the present invention. The method according to the current embodiment will be described in conjunction with FIG. 1.

Referring to FIG. 2, the control unit 140 controls the user interface unit 160 to display the first region which includes information on an original document, and to display the second region which includes information on virtual copy paper in operation 202.

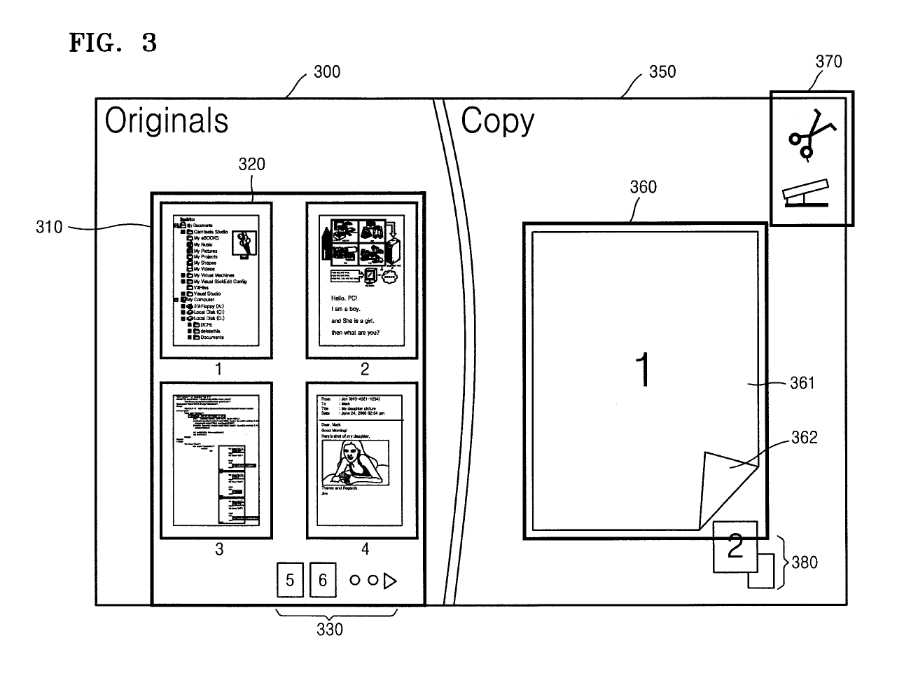

FIG. 3 is a diagram of a user interface screen according to an embodiment of the present invention. The user interface screen according to the current embodiment will be described in conjunction with FIG. 1.

Referring to FIG. 3, in a first region 300, scanned page images 310 of the original document are arranged. For this, the control unit 140 controls the scanner 110 to scan each page of the original document and the scanned page images may be stored into the first storage 120. The control unit 140 controls the user interface unit 140 to display the scanned page images on the first region 300. If the scanned page images do not exist in the case when a copying apparatus does not include the scanner 110 or when the scanning is not required, a default page image which corresponds to each original page may be displayed on the first region 300. If the original document includes too many pages to display on a screen, extra pages are displayed as small or thumbnail images 330 so that a user can see more pages than only the displayed pages. A page number is marked on each page image for convenience of the user.

In a second region 350, a sheet of virtual copy paper 360 is displayed. The sheet of virtual copy paper 360 displays preview information of the result of copying of the original document. As in the first region 300, small images 380 which indicate that extra sheets of virtual copy paper exist may be displayed. Also, a page number may be marked on each page of virtual copy paper.

Referring to FIGS. 2 and 3, after the user inputs a setting instruction in operation 204, the control unit 140 controls the user interface unit 160 to change the display of the second region 350 in accordance with the type of the input setting instruction in operation 206. The setting instruction includes instructions for setting a size of copy paper, a position of copying, scale of copying, single-sided copying or double-sided copying, a number of original pages to be copied on a copy page, and so on. As a result, the result of copying to be output is displayed.

When the user inputs a copy instruction after inputting the setting instruction in operation 208, the control unit 140 controls the output engine 150 to copy the original document in accordance with the display of the second region 350 in operation 210. On each sheet of virtual copy paper, an expected result of copying is displayed and the original document is actually copied in accordance with the size and position displayed on the sheet of virtual copy paper.

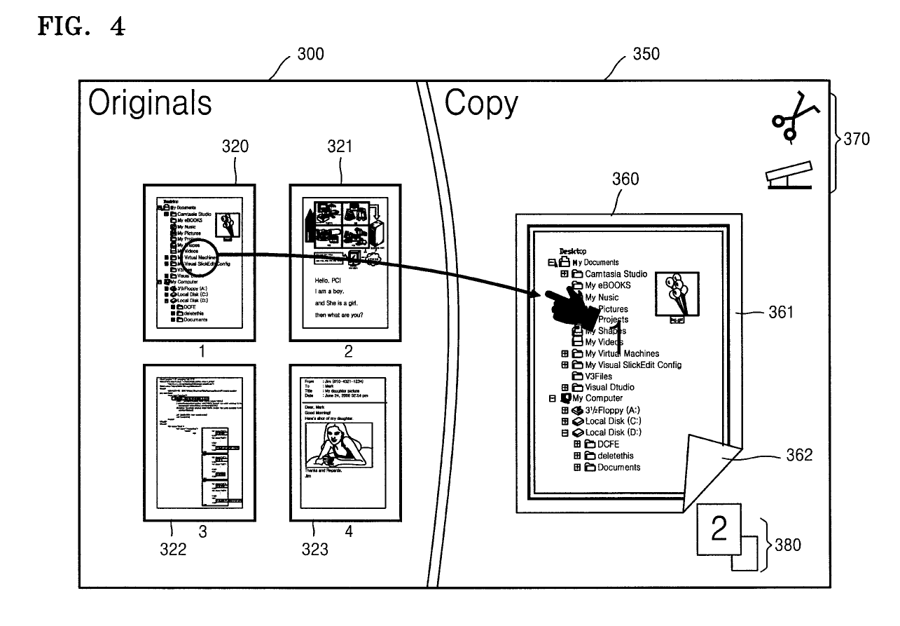

FIG. 4 is a diagram for showing an example of manipulating the user interface screen illustrated in FIG. 3 to copy a document in original scale, according to an embodiment of the present invention.

Referring to FIG. 4, a setting instruction to select an original page of a document and move it to a first sheet of virtual copy paper 360 is input. In this case, the original page may be selected and moved by using a drag-and-drop method, but is not limited thereto. Various methods may be used in accordance with an input device of the copying apparatus. In the current embodiment, a first original page 320 is selected and drag-and-dropped to the first sheet of virtual copy paper 360 and a preview image of the first original page 320 is displayed on the first sheet of virtual copy paper 360. Since the first original page 320 is dropped on a front page 361 of the first sheet of virtual copy paper 360, the first original page 320 will be copied on a front page of real copy paper.

If a setting instruction to select the first original page 320 and move it to the front page 361 of the first sheet of virtual copy paper 360 and to select a second original page 321 and move it to a rear side 362 of the first sheet of virtual copy paper 360 is input, the first and second original pages 320 and 321 are displayed to be mapped to the front and rear sides 361 and 362 of the first sheet of virtual copy paper 360, respectively. That is, if double-sided copying is required, at the status illustrated in FIG. 4, a user may select the second original page 321 and drag-and-drop it to the rear side 362 of the first sheet of virtual copy paper 360. In this case, a preview image of the second original page 321 is displayed on the rear side 362.

Furthermore, by selecting and moving one or two original pages, the same setting instruction may be applied to remaining original pages because it is likely that the user wants to copy all pages the same way. Here, in a case of single-sided copying, other original pages except the selected first original page 320 are displayed to be mapped to other corresponding sheets of virtual copy paper 380. Double-sided copying may be implemented similarly to single-sided copying. Specifically, by mapping the first and second original pages 320 and 321 to the first sheet of virtual copy paper 360, every two pages of the following original pages after the second original page 321 may be appropriately mapped to other sheets of virtual copy paper 380.

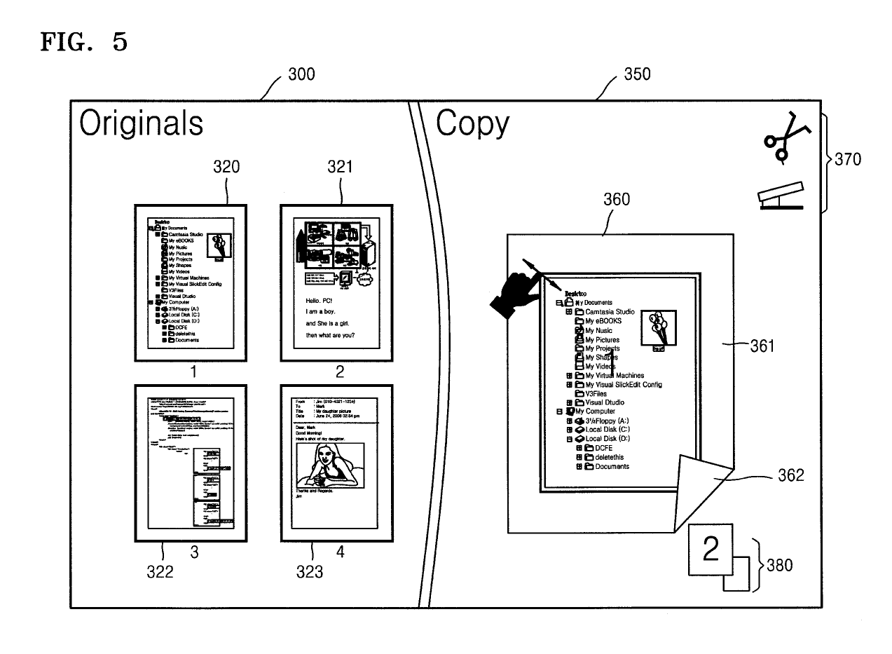

FIG. 5 is a diagram for showing an example of manipulating the user interface screen illustrated in FIG. 4 to copy a document in reduced or enlarged scale, according to an embodiment of the present invention. The example of manipulating the user interface screen according to the current embodiment will be described in conjunction with FIG. 1.

Referring to FIG. 5, a user moves a cursor to an edge region of a preview image displayed on virtual copy paper 360 and adjusts the size of the original page to be copied by dragging the edge region. In this case, a setting instruction to adjust the size of the original page mapped to the virtual copy paper is input and the control unit 140 controls the user interface unit 160 to display the preview image of the original page by adjusting its size in accordance with the adjustment of the user. Therefore, the user can adjust the size of the original image to be copied by using an intuitive user interface so that an original document may be easily copied in reduced or enlarged scale. Furthermore, the size of copy paper may be automatically selected in accordance with the reduced or enlarged scale.

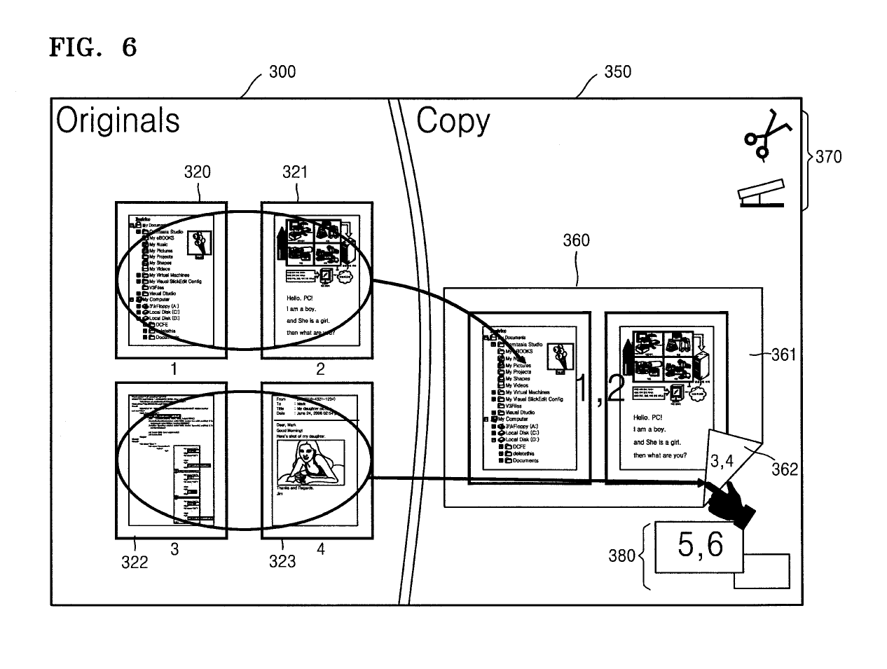

FIG. 6 is a diagram for showing an example of manipulating the user interface screen illustrated in FIG. 3 to copy several pages of a document onto one page, according to an embodiment of the present invention. The example of manipulating the user interface screen according to the current embodiment will be described in conjunction with FIG. 1.

If a setting instruction to select and move a plurality of pages from an original document is input, the control unit 140 controls the user interface unit 160 to display the selected pages on virtual copy paper.

Referring to FIG. 6, a user drags two original pages such as first and second original pages 320 and 321 and drops them on a first sheet of virtual copy paper 360. In this case, the first and second original pages 320 and 321 are mapped to the first sheet of the virtual copy paper 360. Here, the remaining original pages may be mapped to other corresponding sheets of virtual copy paper 380 in groups of the selected amount. In FIG. 6, the user inputs a setting instruction for double-sided copying and thus the first and second original pages 320 and 321 are mapped to a front side 361 of the first sheet of the virtual copy paper 360 and third and fourth original pages 322 and 323 are mapped to a rear side 362 of the first sheet of the virtual copy paper 360. Also, the same setting instruction is applied to other original pages after the fourth original page 323.

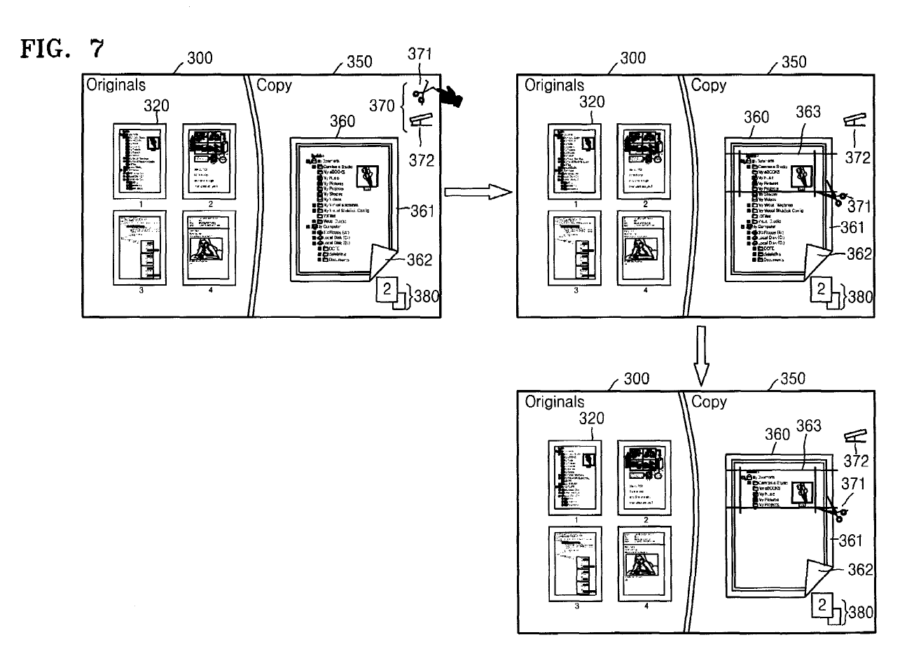

FIG. 7 is a diagram for showing an example of manipulating the user interface screen illustrated in FIG. 4 to copy a portion of a page, according to an embodiment of the present invention. The example of manipulating the user interface screen according to the current embodiment will be described in conjunction with FIG. 1.

Referring to FIG. 7, a scissors icon 371 is selected from among functional icons 370 displayed on the top right corner of the user interface screen and a user cuts a desired portion 363 out by moving the scissors icon 371. In this case, a setting instruction to select the desired portion from an original page mapped to virtual copy paper 360 is input and the control unit 140 controls the user interface unit 160 to display a preview image of the selected portion 363 by removing an unselected portion of the original page.

If the user moves and changes the position of the original page mapped to the virtual copy paper 360, a corresponding setting instruction is input and the control unit 140 controls the user interface unit 160 to display a preview image by changing the position of the original page on the virtual copy paper 360. As such, the position of the original page to be copied may be simply changed on the virtual copy paper 360.

Furthermore, by arranging other functional icons corresponding to different types of inputtable setting instructions on the user interface screen as described above with reference to FIG. 7, the user may easily set a desired function. If the user selects a desired functional icon by clicking it, the selection may be indicated by moving the selected icon to another position as illustrated in FIG. 7 or by enlarging the selected icon. Any of the functional icons may be added or removed according to the user's icon setting instruction.

If the user selects a stapler icon 372, the stapler icon 372 is enlarged and a staplable region is displayed on the virtual copy paper 360. When the user selects a desired position in the staplable region, an instruction to set the position of stapling is input and the set position is displayed on the virtual copy paper 360 or the position of the displayed original page mapped to the virtual copy paper 360 is changed in accordance with the set position of stapling. For example, if the user sets the position of stapling to overlap the content of the original page mapped to the virtual copy paper 360, the position of the displayed original page mapped to the virtual copy paper 360 will be adjusted.

The present invention can also be embodied as computer readable code on a computer readable recording medium.

As described above, according to the present invention, an intuitive interface which even inexperienced users can easily use may be implemented and wasteful use of copy paper due to incorrect editing or setting may be prevented. Also, the interest of the user may rise by realistic user interaction. Furthermore, a user interface according to the present invention is even more convenient due to its structure of short depth.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A user interface method for a copying apparatus, the method comprising:
displaying a first region which includes information on an original document, and displaying a second region which includes information on virtual copy paper which shows the expected result of copying;
changing the display of the second region in accordance with an input setting instruction; and
when a copy instruction is input, copying the original document in accordance with the display of the second region.

2. The method of claim 1, wherein the displaying of the second region comprises displaying preview information of the result of copying of the original document on the virtual copy paper.

3. The method of claim 1, wherein the displaying of the first region comprises:
scanning each page of the original document; and
displaying the result of the scanning on the first region.

4. The method of claim 1, wherein the displaying of the first region comprises displaying a default page image which corresponds to each page of the original document on the first region.

5. The method of claim 1, wherein, if the setting instruction is to select and move a page of the original document shown on the first region onto the virtual copy paper, the changing of the display of the second region comprises displaying the selected page on the virtual copy paper.

6. The method of claim 5, wherein the setting instruction is input when a user drag-and-drops the selected page to the virtual copy paper.

7. The method of claim 5, wherein the displaying of the selected page further comprises displaying remaining pages of the original document, except the selected page, to be mapped to other corresponding sheets of the virtual copy paper.

8. The method of claim 1, wherein, if the setting instruction is to select a first page of the original document shown on the first region and move the first page to a front side of the virtual copy paper and to select a second page of the original document and move the second page to a rear side of the virtual copy paper, the changing of the display of the second region comprises displaying the first and second pages to be mapped to the front and rear sides of the virtual copy paper, respectively.

9. The method of claim 1, wherein, if the setting instruction is to select and move a plurality of pages of the original document shown on the first region, the changing of the display of the second region comprises displaying the selected pages on a sheet of the virtual copy paper.

10. The method of claim 9, wherein the displaying of the selected pages further comprises displaying remaining pages of the original document in groups of a selected number, except the selected pages, to be mapped to other corresponding sheets of the virtual copy paper.

11. The method of claim 1, wherein, if the setting instruction is to adjust the size of the original page mapped to the virtual copy paper, the changing of the display of the second region comprises displaying the original page by changing the size of the original page in accordance with the setting instruction.

12. The method of claim 1, wherein, if the setting instruction is to select a portion of the original page mapped to the virtual copy paper, the changing of the display of the second region comprises displaying the original page by removing an unselected portion of the original page.

13. The method of claim 1, wherein, if the setting instruction is to change a position of the original page mapped to the virtual copy paper, the changing of the display of the second region comprises displaying the original page by changing the position of the original page.

14. The method of claim 1, wherein, if the setting instruction is to set the position of stapling, the changing of the display of the second region comprises displaying the original page mapped to the virtual copy paper by changing the position of the original page and displaying the stapled region on the virtual copy paper according to the set position of stapling.

15. The method of claim 1, further comprising displaying one or more functional icons which correspond to types of inputtable setting instructions, wherein any of the functional icons can be added or removed by an input setting instruction

16. A copying apparatus comprising:
a user interface unit;
an output engine which copies an original document;
a control unit which controls the user interface unit to display a first region which includes information on the original document, and to display a second region which includes information on virtual copy paper which is an expected result of copying, and when a setting instruction is input, controls the user interface unit to change the display of the second region in accordance with the setting instruction, and, when a copy instruction is input, controls the output engine to copy the original document in accordance with the display of the second region.

17. The apparatus of claim 16, wherein the control unit controls the user interface unit to display preview information of the result of copying of the original document on the virtual copy paper.

18. The apparatus of claim 16 further comprising a scanner which scans each page of the original document, wherein the control unit controls the user interface unit to display the result of the scanning on the first region.

19. The apparatus of claim 16, wherein the control unit controls the user interface unit to display a default page image which corresponds to each page of the original document on the first region.

20. The apparatus of claim 16, wherein, if the setting instruction is to select and move a page of the original document shown on the first region onto the virtual copy paper, the control unit controls the user interface unit to display the selected page on the virtual copy paper.

21. The apparatus of claim 20, wherein the setting instruction is input when a user drag-and-drops the selected page to the virtual copy paper.

22. The apparatus of claim 20, wherein the control unit controls the user interface unit to display the remaining pages of the original document, excepting the selected page, to be mapped to other corresponding sheets of the virtual copy paper.

23. The apparatus of claim 16, wherein, if the setting instruction is to select a first page of the original document shown on the first region and move the first page to a front side of the virtual copy paper and to select a second page of the original document and move the second page to a rear side of the virtual copy paper, the control unit controls the user interface unit to display the first and second pages to be mapped to the front and rear sides of the virtual copy paper, respectively.

24. The apparatus of claim 16, wherein, if the setting instruction is to select and move a plurality of pages of the original document shown on the first region, the control unit controls the user interface unit to display the selected pages on a sheet of the virtual copy paper.

25. The apparatus of claim 24, wherein the control unit controls the user interface unit to display the remaining pages of the original document in groups of a selected number, except the selected pages, to be mapped to other corresponding sheets of the virtual copy paper.

26. The apparatus of claim 16, wherein, if the setting instruction is to adjust the size of the original page mapped to the virtual copy paper, the control unit controls the user interface unit to display the original page by changing the size of the original page in accordance with the setting instruction.

27. The apparatus of claim 16, wherein, if the setting instruction is to select a portion of the original page mapped to the virtual copy paper, the control unit controls the user interface unit to display the original page by removing an unselected portion of the original page.

28. The apparatus of claim 16, wherein, if the setting instruction is to change a position of the original page mapped to the virtual copy paper, the control unit controls the user interface unit to display the original page by changing the position of the original page.

29. The apparatus of claim 16, wherein, if the setting instruction is to set the position of stapling, the control unit controls the user interface unit to display the original page mapped to the virtual copy paper by changing the position of the original page and to display the stapled region on the virtual copy paper according to the set position of stapling.

30. The apparatus of claim 16, wherein the control unit controls the user interface unit to display one or more functional icons which correspond to types of inputtable setting instructions, and any of the functional icons can be added or removed by an input setting instruction.

31. A computer readable recording medium having recorded thereon a computer program for executing the method of claim 1.
